(19) United States
(12) Patent Application Publication
(10) Pub. No.: US 2008/0219680 A1
(43) Pub. Date: Sep. 11, 2008

(54) OPTICAL RECEIVING APPARATUS AND BALANCE ADJUSTMENT METHOD

(76) Inventors: Kumi Omori, Tokyo (JP); Tadashi Koga, Tokyo (JP)

Correspondence Address: NEC CORPORATION OF AMERICA, 6535 N. STATE HWY 161, IRVING, TX, 75039, US

(21) Appl. No.: 12/042,682

(22) Filed: Mar. 5, 2008

(30) Foreign Application Priority Data
Mar. 7, 2007 (JP) 2007-057346

(51) Int. Cl. H04B 10/06

(52) U.S. Cl. 398/212; 398/9

(57) ABSTRACT

Disclosed is a optical receiving apparatus including a balanced receiver comprising first and second light receiving elements which receive respective optical signals from first and second ports of a 1-bit delay interferometer, monitor units that monitor amplitudes and delays at the first and second light receiving elements, respectively, control units that variably respectively control attenuations and delays on the paths between the first and second output ports of the 1-bit delay interferometer and the first and second light receiving elements, based on monitored results by the monitor units.

### REFERENCE TO RELATED APPLICATION

This application is based upon and claims the benefit of the priority of Japanese patent application No. 2007-057346, filed on Mar. 7, 2007, the disclosure of which is incorporated herein in its entirety by reference thereto.

### FIELD OF THE INVENTION

This invention relates to an optical receiving apparatus and, more particularly, to an optical receiving apparatus that includes a balanced receiver, and to a balance adjustment method.

### BACKGROUND OF THE INVENTION

A DPSK (Differential Phase Shift Keying) modulation system, used for optical transmission, differentially encodes a phase change between information data sequences, generated from binary signals, to perform phase modulation on DC light. For example, a differentially encoded signal is generated in which the non-presence and the presence of a phase change between neighboring data symbols assume an ON-state and an OFF-state, respectively. To demodulate an optical signal which has been modulated in accordance with the DPSK system, a 1-bit delay interferometer and a balanced receiver (also termed as a balanced optical receiver), including two light receiving elements, is used. The phase signal, encoded as the relative phase between neighboring bits, is branched by the 1-bit interferometer, as light intensity signals, to a port where light intensity is reinforced by interference and to a port where light intensity is weakened by interference, thereby achieving demodulation. As for details of the 1-bit delay interferometer and the balanced receiver in the optical receiver of the DPSK modulated light, reference may be made to the disclosure of Patent Document 1, for instance.

FIG. 5 is a diagram showing the configuration of a typical light receiving apparatus, adapted for receiving a DPSK modulated optical signal. Referring to FIG. 5, a 1-bit delay interferometer 1 includes an input waveguide 101, couplers 102 and 103, a waveguide 104 and a delay waveguide, made up of waveguides 105 and 107, and a light delay element 106. The input waveguide 101 wave-guides a DPSK modulated incident light. The coupler 102 splits the incident light into two divided lights. The coupler 103 couples the two divided lights split by the coupler 102 to generate an interference optical signal and outputs the interference optical signal, as light intensity signal. The coupler 103 changes over the output destinations of the interference optical signal, depending on whether or not the relative phases of the two divided lights are coincident from one timeslot to the next. The coupler 103 outputs the interference optical signal, as light intensity signal, at it changes over the output destinations, based on phase relationships between the signal transmitted on the waveguide 104 and that transmitted via the light delay element 106. More specifically, the coupler 103 outputs the interference optical signal to an output waveguide 108 in case the relative phases of the two signals coincide with each other, and to an output waveguide 109 if otherwise. The signal light propagated on the waveguide having the light delay element 106 is delayed by one timeslot in comparison with the signal light propagated on the waveguide having the light delay element 106.

On the succeeding stage of the 1-bit delay interferometer 1, there is provided a balanced receiver 2 including first and second light receiving elements (photodiodes) 201 and 202. A positive reverse-bias voltage is applied to the cathode of the light receiving element 201, whereas a negative reverse-bias voltage is applied to the anode of the light receiving element 202. The anode of the light receiving element 201 is connected to the cathode of the light receiving element 202. The first and second light receiving elements 201 and 202 transform the light intensity signals, output from the output waveguides 108 and 109, respectively, into electronic signals, and subtract electronic currents flowing through the first and second light receiving elements 201 and 202 relative to each other to generate a differential signal, by way of demodulating the DPSK modulated light. A clock signal is extracted by the clock recovery unit 3 from an output of the balanced receiver 2, and a received signal is discriminated and recovered with the use of the so generated clock signal. The clock recovery unit 3 extracts and recovers the clock signal from the received signal. The clock recovery unit 3 may, for example, be a PLL (Phase Locked Loop) circuit, detecting the phase difference between the clock signal, as an output signal of an internal oscillator, and the input signal, and exercising control to make the frequency and the phase of the internal oscillator coincide with those of the input signal. The regeneration unit 4 decides a digital value (0/1) of the input signal, based on a threshold value, and re-times the resulting signal, based on an output clock from the clock recovery unit 3.

Patent Document 2 discloses a configuration of a receiving device for decoding the DQPSK signal provided with a phase controller that supplies a control signal (voltage) to a 1-bit delay interferometer to perform control for stabilizing optical phase in the interferometer.

[Patent Document 1]

JP Patent Kokai Publication No. JP-P2006-39037A

[Patent Document 2]

JP Patent Kokai Publication No. JP-P2006-295603A

### SUMMARY OF THE DISCLOSURE

The entire disclosure of Patent Documents 1 and 2 are incorporated herein by reference thereto. The following analysis is given by the present invention.

It is extremely difficult to obtain a balanced receiver including first and second receiving elements whose amplitude, delay and frequency characteristics are the same. That is, the first and second receiving elements of a balanced receiver have respective variations in characteristics. The received demodulated signal undergoes deterioration in reception sensitivity due to unbalanced characteristics of the balanced receiver.

Accordingly, it is an object of the present invention to provide a balanced receiver in which deterioration in reception sensitivity, brought about by unbalanced characteristics in the balanced receiver, may be suppressed to improve the receiver's performance, and a balance adjustment method.

In accordance with the present invention, there are provided a variable optical delay adjustment unit and a variable light attenuator to automatically correct fluctuations in characteristics of a balanced receiver.

In accordance with one aspect of the present invention, there is provided a balance adjustment apparatus that adjusts the balance of a balanced receiver including first and second light receiving elements which receive respective optical signals from two different ports of a 1-bit delay interferometer. The balance adjustment apparatus comprises monitor means that monitors amplitude and/or delay of each of the first and second light receiving elements; and control means that variably controls attenuation and/or delay in each of optical signals on first and second paths between first and second ports of the 1-bit delay interferometer and the first and second light receiving elements, based on monitored results by the monitor means.

In accordance with another aspect of the present invention, there is provided a light receiving apparatus comprising:

a balanced receiver including first and second light receiving elements for respectively receiving optical signals from first and second output ports of a 1-bit delay interferometer;

first and second amplitude monitor units for monitoring amplitudes of outputs of the first and second light receiving elements, respectively;

first and second delay monitor units for monitoring delays of the outputs of the first and second light receiving elements, respectively;

first and second light attenuators placed respectively on first and second paths between the first and second ports of the 1-bit delay interferometer and the first and second light receiving elements;

first and second optical delay adjustment units placed respectively on first and second paths between the first and second ports of the 1-bit delay interferometer and the first and second light receiving elements;

a light attenuation controller for controlling respective attenuations of the first and second light attenuators, based on monitored results by the first and second amplitude monitor units; and

an optical delay controller for controlling respective delays of the first and second optical delay adjustment units, based on monitored results by the first and second delay monitor means

The light receiving apparatus according to the present invention may further comprise means for controlling the 1-bit delay interferometer based on the monitored amplitudes of the first and second light receiving elements.

The light receiving apparatus according to the present invention may further comprise a band-pass filter and a spectrum monitor as means for controlling the delay interferometer.

In another aspect of the present invention, there is provided a method for adjusting the balance of a balanced receiver including first and second light receiving elements for respectively receiving optical signals from two different ports of a 1-bit delay interferometer. The method comprises:

monitoring amplitude and/or delay of each of the first and second light receiving elements; and

variably controlling attenuation and/or delay on each of first and second paths between first and second ports of the 1-bit delay interferometer and the first and second light receiving elements, based on monitored results.

The meritorious effects of the present invention are summarized as follows.

According to the present invention, it is possible to suppress deterioration in reception sensitivity, otherwise generated due to unbalance in amplitude, delay and frequency characteristics, by adjusting the balance in the balanced receiver, thereby improving the receiver's performance.

Still other features and advantages of the present invention will become readily apparent to those skilled in this art from the following detailed description in conjunction with the accompanying drawings wherein examples of the invention are shown and described, simply by way of illustration of the mode contemplated of carrying out this invention. As will be realized, the invention is capable of other and different examples, and its several details are capable of modifications in various obvious respects, all without departing from the invention. Accordingly, the drawing and description are to be regarded as illustrative in nature, and not as restrictive.

### BRIEF DESCRIPTIONS OF THE DRAWINGS

FIG. 1 is a block diagram for illustrating a first example of the present invention.

FIGS. 2A and 2B are schematic views for illustrating the presence or absence of fluctuations in the phase and in the amplitude in a balanced receiver.

FIG. 3 is a block diagram for illustrating a second example of the present invention.

FIG. 4 is a block diagram for illustrating a third example of the present invention.

FIG. 5 is a schematic view for illustrating a typical configuration of a receiver of a DPSK modulated optical signal.

### PREFERRED MODES OF THE INVENTION

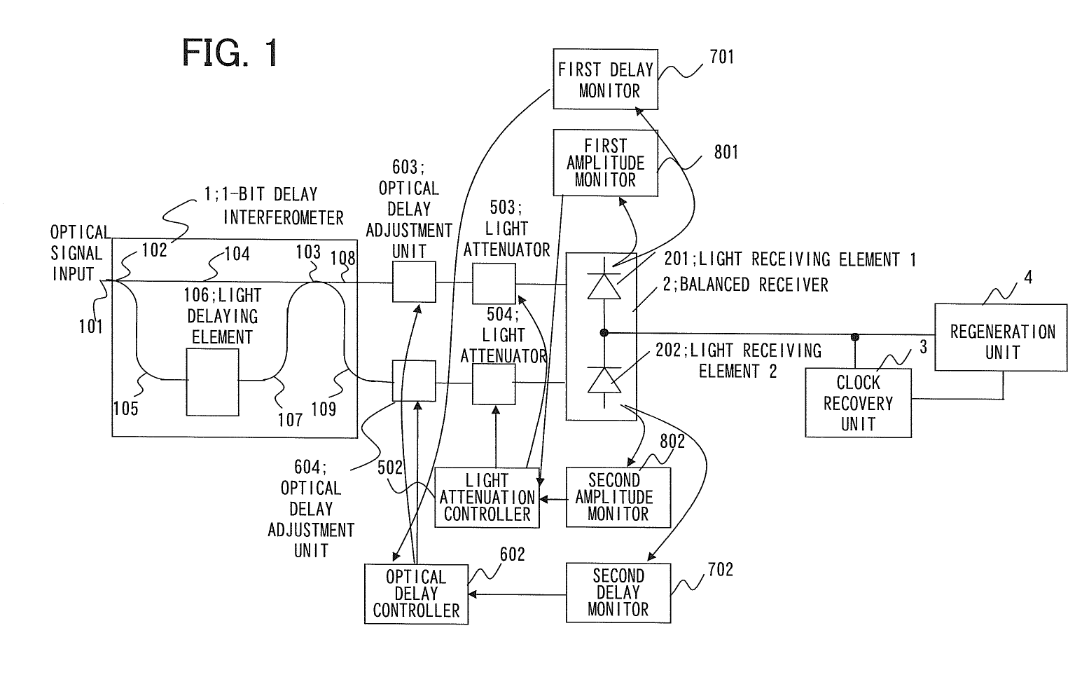

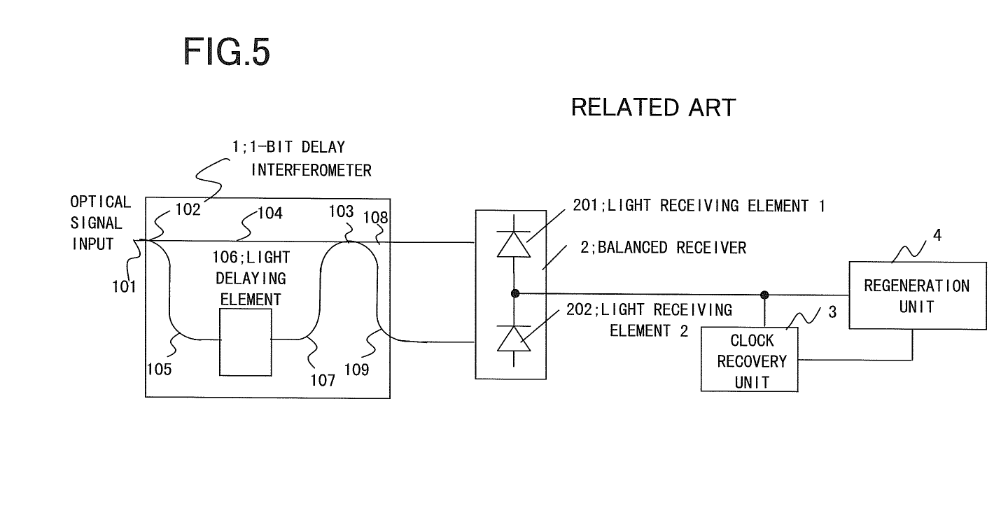

FIG. 1 shows the configuration of an optical receiving apparatus according to a first example of the present invention. Referring to FIG. 1, in the optical receiving apparatus according to the present example, there are provided, in addition to the customary configuration shown in FIG. 5, a light attenuation controller 502, light attenuators 503 and 504, an optical delay controller 602, optical delay adjustment units 603 and 604, first and second delay monitors 701 and 702 and first and second amplitude monitors 801 and 802. In FIG. 1, a 1-bit delay interferometer 1, a balanced receiver 2, a clock recovery unit 3 and a regeneration unit 4 are the same as the corresponding components shown in FIG. 5 and hence are not here reiteratively described for simplicity.

In the present example, signals from two ports of output waveguides 108 and 109 of the 1-bit delay interferometer 1 (light intensity signals) are adjusted for delay by the optical delay adjustment units 603 and 604, respectively, and controlled in amplitude by the light attenuators 503 and 504, respectively, before being supplied to two light receiving elements 201 and 202 of the balanced receiver 2, respectively. A differential signal between the currents flowing through the light receiving elements 201 and 202, respectively, is output as an output signal of the balanced receiver 2. A clock is extracted by the clock recovery unit 3 from the output signal of the balanced receiver 2, and a received signal is discriminated and recovered by the regeneration unit 4.

With the present example, the balance correction of amplitude, delay and frequency response of the balanced receiver 2 may be implemented by the light attenuators 503 and 504 and the optical delay adjustment units 603 and 604.

The first delay monitor 701 monitors the delay of an output at a first port of the balanced receiver 2 (output of the light receiving element 201). The first amplitude monitor 801 monitors the amplitude of an output at the first port of the balanced receiver 2 (output of the light receiving element 201). The second delay monitor 702 monitors the delay of an output at a second port of the balanced receiver 2 (output of the light receiving element 202). The second amplitude monitor 802 monitors the amplitude of the output at the second port of the balanced receiver 2 (output of the light receiving element 202).

The optical delay controller 602 controls respective delays of the optical delay adjustment units 603 and 604 based on monitored results by the first and second delay monitors 701 and 702.

The optical delay adjustment units 603 and 604 each vary the delay of light based on setting from the optical delay controller 602.

The light attenuation controller 502 controls respective attenuations of the light attenuators 503 and 504 based on monitored results by the first and second amplitude monitors 801 and 802.

The light attenuators 503 and 504 each vary the attenuation of light based on setting at the light attenuation controller 502.

With the present example, the balanced state of the balanced receiver 2 may thus be adjusted in advance by measuring respective delays and amplitudes of the outputs of the first and second ports, setting respective delays at the optical delay adjustment units 603 and 604 by the optical delay controller 602, and by setting respective attenuations at the light attenuators 503 and 504 by the light attenuation controller 502.

To adjust the balanced state of the balanced receiver 2, control is exercised so as to provide for equal monitor amplitudes at the first and second amplitude monitors 801 and 802.

As the light attenuators 503 and 504, variable light attenuators (VOAs), for example, may be used.

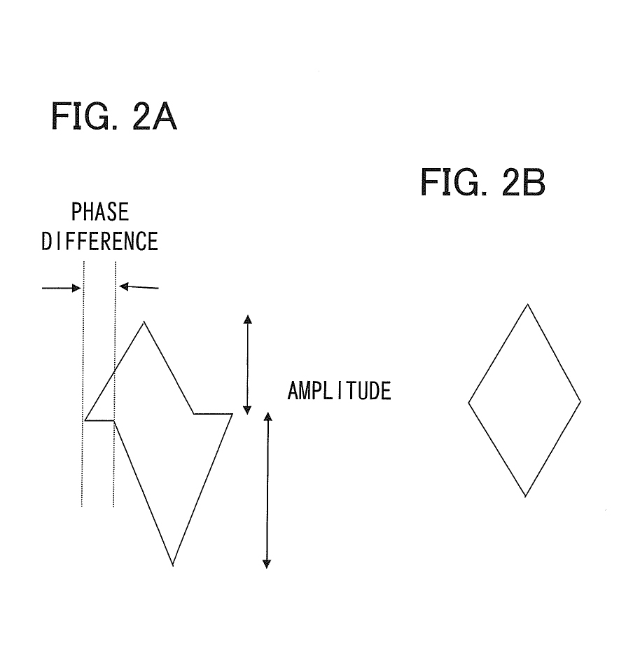

In the balanced receiver 2 in the DPSK signal receiving device, fluctuations in amplitude and phase tend to be produced due to fluctuations in characteristics of the light receiving elements 201 and 202, for example. Hence, the output waveform is as shown in FIG. 2A, that illustrates the state where balance adjustment of the balanced receiver 2 is not carried out, by way of a comparative case.

If, in contrast to this comparative case, the balance adjustment of the balanced receiver 2 is carried out to correct the amplitude and the phase, as in the present example, the waveform exhibits a state where the amplitude and the phase become coincident or balanced, as shown in FIG. 2B.

Meanwhile, such devices capable of varying the optical path length are used as the optical delay adjustment units 603 and 604. A stepping motor, for example, may be used to variably control the light delay.

The phase states as monitored by the first and second delay monitors 701 and 702 are controlled to be equal to each other. The first and second delay monitors 701 and 702 detect the phase difference by, for example, a PLL circuit provided with a phase comparator (PD).

The first and second amplitude monitors 801 and 802 respectively detect the peak values of the respective currents in the light receiving elements 201 and 202 of the balanced receiver 2 or the peak value of the amplitude of the output waveform of the balanced receiver 2. That is, the first and second amplitude monitors 801 and 802 are composed by current monitors, such as current sense amplifiers, that monitor the currents flowing through light receiving elements (photodiodes) 201 and 202 of the balanced receiver 2, or by peak detectors.

With the present example, it is possible to reduce deterioration in the reception sensitivity in the balanced receiver 2, ascribable to unbalanced amplitude, delay or frequency response, and to improve the receiver's performance

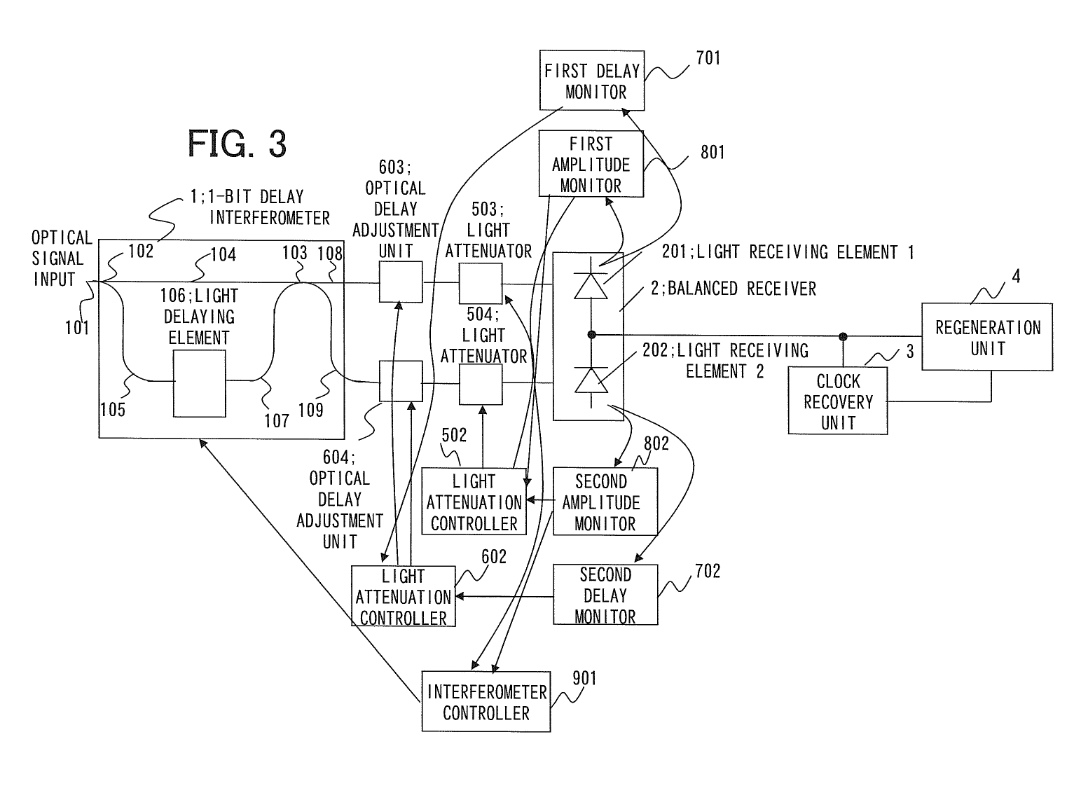

FIG. 3 shows the configuration of a second example of the present invention. In the example of FIG. 3, an interferometer controller 901 is added to the configuration shown in FIG. 1.

In the present example, the balanced receiver 2 has been corrected for fluctuations in characteristics, based on amplitude control and delay control in accordance with the above-described first example. The 1-bit delay interferometer 1 is thus controlled under the conditions of coincident delay and amplitude characteristics.

In the case of the DPSK optical signal, the control of the 1-bit delay interferometer 1 may be said to be optimized when the output amplitude or the monitored current of the balanced receiver 2 is maximum. In the present example, the interference controller 901 receives monitored results of the first and second amplitude monitors 801 and 802, and manages control of the 1-bit delay interferometer 1 so that the values of the amplitude as monitored by the first and second amplitude monitors 801 and 802 will be maximum. The control at the 1-bit delay interferometer 1 may, for example, be the control of the phase of the carrier signals for signal light on the two optical paths.

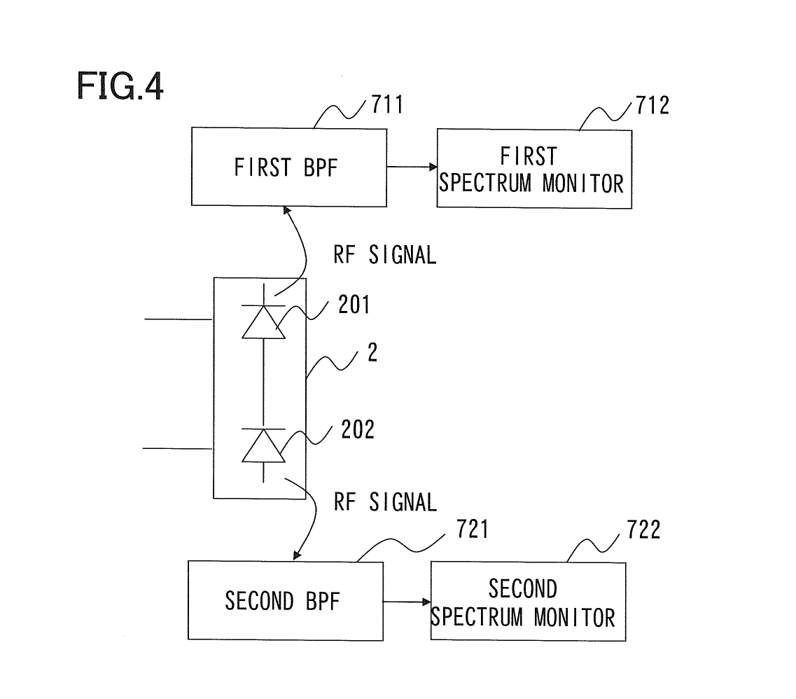

FIG. 4 shows the configuration of a third example of the present invention. Specifically, FIG. 4 shows an illustrative configuration of the first delay monitor 701 or the second delay monitor 702 in the first or second example shown in FIG. 1 or 3. In the present example, shown in FIG. 4, the first delay monitor 701 includes a first band-pass filter (BPF) 711 that receives an output (RF signal) of a light receiving element 201 of the balanced receiver 2, and a first spectrum monitor 712 that finds the spectral power of an output of the first band-pass filter (BPF) 711. In similar manner, the second delay monitor 702 includes a second band-pass filter (BPF) 721 that receives an output (RF signal) of a light receiving element 202 of the balanced receiver 2, and a second spectrum monitor 722 that finds the spectral power of an output of the second band-pass filter (BPF) 721.

The optical delay controller 602 of FIG. 1 or 3 is responsive to outputs of the first and second spectrum monitors 712 and 722 to control the optical delay adjustment units 603 and 604 so that the spectral power output from the first spectrum monitor 712 will be equal to that output from the second spectrum monitor 722. It is observed that the passbands of the first and second band-pass filters (BPFs) 711 and 721 are set to predetermined frequency values depending on the bit rate of the principal signal.

As a modification of the above examples, it is possible to provide either an amplitude monitor or a delay monitor.

Although the present invention has so far been described with reference to preferred examples, the present invention is not to be restricted to the examples. It is to be appreciated that those skilled in the art can change or modify the examples without departing from the spirit and the scope of the present invention.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A balance adjustment apparatus for adjusting the balance of a balanced receiver including first and second light receiving elements which respectively receive optical signals from two different ports of a 1-bit delay interferometer; said balance adjustment apparatus comprising:
monitor means that monitors amplitude and/or delay of each of outputs of said first and second light receiving elements; and
control means that variably controls attenuation and/or delay in each of optical signals on first and second paths between first and second ports of said 1-bit delay interferometer and said first and second light receiving elements, based on monitored results by said monitor means.

2. A balance adjustment apparatus for adjusting the balance of a balanced receiver including first and second light receiving elements which respectively receive optical signals from two different ports of a 1-bit delay interferometer; said balance adjustment apparatus comprising:
a monitor unit that monitors amplitude and/or delay of each of outputs of said first and second light receiving elements; and
a control unit that variably controls attenuation and/or delay in each of optical signals on first and second paths between first and second ports of said 1-bit delay interferometer and said first and second light receiving elements, based on monitored results by said monitor unit.

3. A light receiving apparatus including the balance adjustment apparatus as set forth in claim 1, wherein said balanced receiver receives the optical signals from first and second output ports of said 1-bit delay interferometer receiving an input optical signal.

4. A light receiving apparatus comprising:
a balanced receiver including first and second light receiving elements which receive respective optical signals from first and second output ports of a 1-bit delay interferometer;
first and second amplitude monitor units which monitor amplitudes of outputs of said first and second light receiving elements, respectively;
first and second delay monitor units which monitor delays of the outputs of said first and second light receiving elements, respectively; first and second light attenuators provided respectively on first and second paths between said first and second ports of said 1-bit delay interferometer and said first and second light receiving elements;
first and second optical delay adjustment units provided respectively on the first and second paths between said first and second ports of said 1-bit delay interferometer and said first and second light receiving elements;
a light attenuation controller that controls respective attenuations of said first and second light attenuators, based on monitored results by said first and second amplitude monitor units; and
an optical delay controller that controls respective delays of said first and second optical delay adjustment units, based on monitored results by said first and second delay monitor units.

5. A light receiving apparatus according to claim 3, further comprising:
an interferometer controller that controls said 1-bit delay interferometer, based on the monitored results of the amplitudes of said first and second light receiving elements.

6. A light receiving apparatus according to claim 4, further comprising:
an interferometer controller that controls said 1-bit delay interferometer, based on the monitored results of the amplitudes of said first and second light receiving elements by said first and second amplitude monitor units.

7. A light receiving apparatus according to claim 4, wherein said first and second amplitude monitor units each include:
a band-pass filter that receives an output of said light receiving element to selectively pass a preset band signal; and
a spectrum monitor that receives an output of said band-pass filter to monitor the spectral power.

8. A method for adjusting the balance of a balanced receiver including first and second light receiving elements that receive respective optical signals from two different ports of a 1-bit delay interferometer; said method comprising:
monitoring amplitude and/or delay of each of outputs of said first and second light receiving elements; and
variably controlling attenuation and/or delay on each of first and second paths between first and second ports of said 1-bit delay interferometer and said first and second light receiving elements, based on monitored results.
